(19) United States
(12) Patent Application Publication
(10) Pub. No.: US 2014/0325676 A1
(43) Pub. Date: Oct. 30, 2014

(54) METHOD AND SYSTEM FOR DIGITAL CONTENTS LENDING

(71) Applicant: ALCATEL LUCENT, Paris (FR)

(72) Inventors: Mathieu Beauvais, Nozay (FR); Julien Robinson, Nozay (FR)

(21) Appl. No.: 14/358,767

(22) PCT Filed: Nov. 14, 2012
(86) PCT No.: PCT/EP2012/072634

§ 371 Date: May 16, 2014

(30) Foreign Application Priority Data
Nov. 16, 2011 (EP) 11189293.1

(51) Int. Cl. G06F 21/10

(52) U.S. Cl. CPC G06F 21/10
USPC 726/27

(57) ABSTRACT

A method for transferring a digital right management-protected digital content from a first device (10) to a second device, said first and second devices respectively comprising a contact point (14), a contact communication unit (15) and a standard communication functionality (16), said digital content being protected by a digital right management module (12) and the digital right management license (13), said method comprising the following steps:—sending a code from the first device to the second device;—activating the contact point (1) and the contact communication unit (15) of the first device;—if there is a physical contact between the contact point (14) of the first device and the contact point of the second device within a predefined period of time, then sending the code from the second device to the first device for verification;—checking, by the first device, of the code received from the second device;—if the code received by the first device is correct, transmitting the digital right management license (13) of the first device to the second device and deactivating the digital right management license (13) of the first device.

### FIELD OF THE INVENTION

This invention relates generally to protected digital contents handling.

### BACKGROUND OF THE INVENTION

By offering new ways of sale, lending and disseminating, it seems apparent that the rapid growth of electronic communications networks and the widespread use of end-user electronic devices present an immense opportunity for digital contents providers.

A digital content relates, here, to any transferable content from one electronic device to another one, such as a movie, a music file, a software application, or more generally any file or directory. The term “electronic device” is meant broadly and not restrictively, to include any system able to render a digital content (a computer, a personal digital assistant, a smartphone, a digital audio player, an e-book reader, a tablet computer for example).

In this regards, different business models have been developed governing commercial digital contents distribution. However, it is worthwhile to mention that such business models stand up only if Digital Rights Management contracts—specified by content providers—are fully respected by consumers. Otherwise, illegal copying and unlimited distribution on massive scales of a digital content surely undermine its business model and its content provider rights.

In fact, the ability of anyone—potentially malicious end-users—to make perfect copies and the ease by which those copies can be distributed (i.e. sold, lent, offered or shared) facilitate misuse and piracy.

Accordingly, among main issues that limit the expansion of digital content distribution, as expected by content providers, is the absence of a management method for digital content transfer between electronic devices, particularly in connection with lending, or any other authorized distribution form of a legally obtained digital content.

Thus, the major challenge for digital content providers is to seek ways whereby secure and widespread distribution—mainly lending—between users of copyrighted digital contents may be possible without DRM violation (i.e. ensuring, for example, that an ebook lending will not result in widespread piracy), making the establishment of a copyright-respecting method for digital contents lending between users an urgent need.

An object of the present invention is to prevent illegal distribution of copyrighted digital contents, while benefiting from flexibility of content usage promised by mobile electronic devices.

Another object of the present invention is to preserve the business model of digital content distribution over mobile communications networks.

Another object of the present invention is to expand lending markets of digital contents.

Another object of the present invention is to enforce DRM fulfillment after that contents have been distributed to end-users.

Another object of the present invention is to provide an ease-of-use method for digital contents lending between end-users while DRM fulfilling.

Another object of the present invention is to provide a copyright-respecting method for digital contents transfer between users.

### DESCRIPTION OF THE DRAWING

The objects, advantages and other features of the present invention will become more apparent from the following disclosure and claims. The following non-restrictive description of preferred embodiments is given for the purpose of exemplification only with reference to the accompanying drawing in which

FIG. 1 is a block diagram illustrating functional modules of an end-user device according to a preferred embodiment; and

FIG. 2 shows illustrative method steps for a DRM-respecting transfer of a protected digital content between two end-user devices.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key of critical elements of the invention or to delineate the scope of the invention. Its sole purpose is to present some concepts in a simplified form as a prelude to the more detailed description that is discussed later.

The present invention relates to a method for transferring a digital right management-protected digital content from a first device to a second device, said first and second devices respectively comprising a contact point, a contact communication unit and a standard communication functionality, said digital content being protected by a digital right management module and the digital right management license, said method comprising the following steps:
sending a code from the first device to the second device ;
activating the contact point and the contact communication unit of the first device;
if there is a physical contact between the contact point of the first device and the contact point of the second device within a predefined period of time, then sending the code from the second device to the first device for verification;
checking, by the first device, of the code received from the second device;
if the code received by the first device is correct, transmitting the digital right management license of the first device to the second device and deactivating the digital right management license of the first device.

In accordance with a broad aspect, the digital right management license is transmitted to the second device from a distant server.

The present invention further relates to a device for transferring a digital right management-protected digital content comprising a contact point configured to detect its physical contact with a contact point of a second device and to enable sending a code from the said device to the said second device.

In accordance with a broad aspect the above device further comprises a contact communication unit configured to control the contact point, at least a standard communication functionality, means for transmitting a code, and means for retrieving a code from a distant server.

The present invention further relates to a computer program product adapted to perform the method cited above.

While the invention is susceptible to various modification and alternative forms, specific embodiments thereof have been shown by way of example in the drawings. It should be understood, however, that the description herein of specific embodiments is not intended to limit the invention to the particular forms disclosed.

It may of course be appreciated that in the development of any such actual embodiments, implementation-specific decisions should be made to achieve the developer's specific goal, such as compliance with system-related and business-related constraints. It will be appreciated that such a development effort might be time consuming but may nevertheless be a routine understanding for those or ordinary skill in the art having the benefit of this disclosure.

### DETAILED DESCRIPTION OF ILLUSTRATIVE EMBODIMENTS

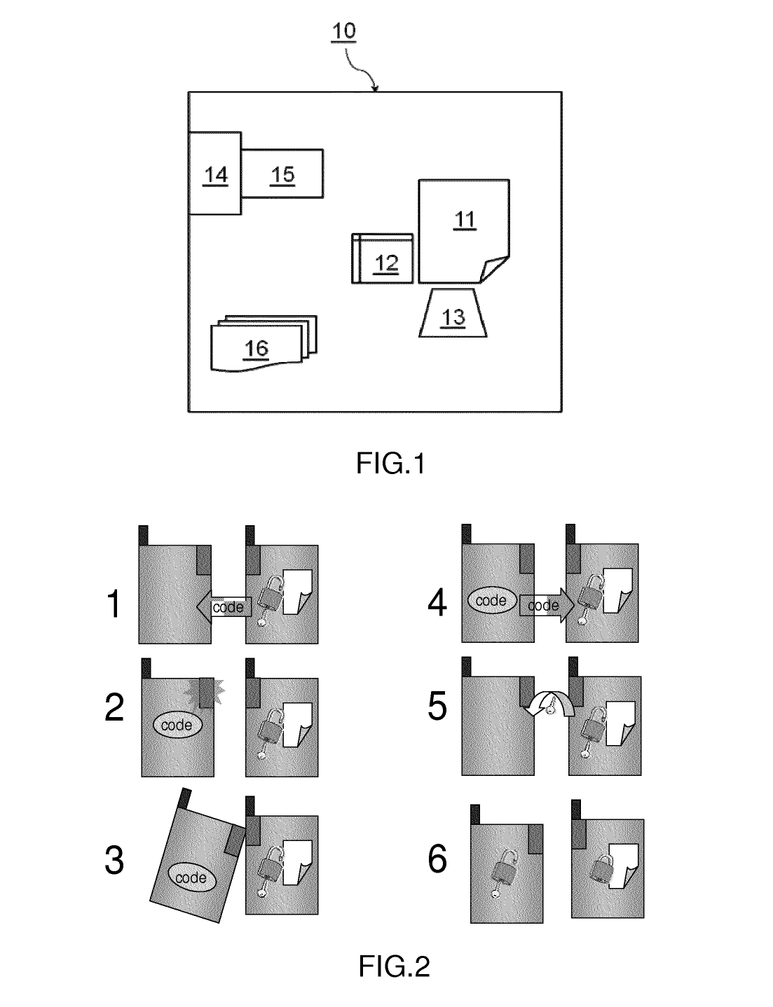

FIG. 1 illustrates an end-user device 10 (a smartphone, a tablet computer, a personal digital assistant, a mobile/desktop computer, or any home entertainment device for example) comprising
a protected digital content 11 by a DRM module 12 and its correspondent license 13. The DRM-license 13 authorizes the use of the DRM module 12 which enables/disables the access to the digital content 11. DRM systems generally incorporate encryption and usage conditions (terminal, account, usage time, payment, user name, serial number, watermark, print/read/save permission for examples);
a contact point 14 under the control of a contact communication unit 15 that interacts with the rest of the main end-user device 10 components.

Further, the end-user device 10 comprises at least a standard communication functionality 16 such as Wi-Fi, Bluetooth®, GSM, or EDGE for example.

The contact point 14 is configured to detect its physical contact with a contact point of another device and to enable information/data exchange (sending/receiving a code for example) between these two devices according to a predefined protocol. The document EP2216910 (“Method and equipment for configuring radio communications”, Alcatel Lucent) describes an example of such a contact point equipment.

According to one embodiment, the transfer (i.e. the lending) of the DRM-protected digital content 11 from the first end-user device 10 to a second end-user device—in turn, provided with a contact point, a contact communication unit and a standard communication functionality—requires
the physical contact of these two end-user devices; and
that the DRM license 13 be transferable from the first end-user device 10 to the second one.

It is to be noted that, both above end-user devices have to be connected to a same communication area network (the same Wi-Fi hotspot, the same umbrella macro base station, the same femto-cell, the same Local Area Network for example), which has the effect to avoid piracy.

The transfer of the digital content 11 from the first device 10 to a second device is assured by means of devices touching (also known as devices toothing) through their contact points. The document EP2216910 (“Method and equipment for configuring radio communications”, Alcatel Lucent) discloses a method for data transfer in a secure way between mobiles devices when they are guaranteed to be in physical contact.

As an illustrative example consider the case, depicted in FIG. 2, wherein a user of a first mobile device (a smartphone for example) wishing to lend a DRM-protected digital content (an ebook for example) to a user of a second mobile device (a smartphone, a laptop, or a tablet for example). Thus, an ebook as a digital content is to be transferred from a first mobile device to a second mobile device while respecting its DRM constraints. Both mobile devices are equipped with compatible contact points and contact communications units that guarantee that the two devices have effectively made physical contact and the identification thereof.

Then, according to user instructions, a user interface may be displayed on the first mobile device for managing the transfer of the DRM-protected digital content (i.e. the ebook).

Under the control of the user, the first mobile device sends (using appropriate protocol) a lending code to the second mobile device, for example a 10 digit lending code, available for a short amount of time (e.g. 30 seconds) (step 1 in FIG. 2).

Subsequently, the second mobile device activates its contact communication unit and its contact point (step 2 in FIG. 2). If the first mobile device touches the second mobile device (i.e. a physical contact between the contact points of the first and second mobile) within the predefined amount of time (30 seconds for example) after sending the lending code (step 3 in FIG. 2), then the lending code is sent by the second mobile device to the first mobile device for verification (step 4 in FIG. 2).

Afterward, the first mobile device checks the lending code received from the second mobile device. If it is correct, the first mobile device transmits (step 5 in FIG. 2) the DRM-license to the second mobile device and at the same time its own DRM-license is deactivated (step 6 in FIG. 2).

Finally, the DRM-protected digital content is transmitted from the first mobile device to the second one via any appropriate communication channel (via the contact communication unit, or via the communication area network to which both mobile devices are connected for example).

Alternatively, the second mobile device may receive (or download) the digital content to be lent from another source than from the first mobile device (from a distant server for example).

Advantageously, the above steps may be done in a transparent way for the user, who would only see a user-friendly display for lending or borrowing a digital content. DRM and transmission details may be hidden.

Advantageously, the required physical contact between end-user devices for DRM-protected digital contents transfer therebetween may avoid digital contents misappropriation via, for example, NFC techniques.

According to the above embodiment, DRM is stored on the end-user device. Alternatively, a centralized hosting method of DRM is adopted, permitting the transfer of digital contents between end-user devices in a centralized manner. In fact, a server keeps track of the association between devices identities and licenses. Advantageously, this provides an authentication before transferring a license from one device to another, while avoiding the use of a dongle.

A license—associated to a first mobile device and being known to a centralized server—may be transmitted to a second mobile device using the centralized server (a distant server) as follow:
the user of the first mobile device chooses to transfer a license (or a DRM module) on a dedicated interface;
the first mobile device connects to the centralized server;
using, for example, web services over HTTPS, the first mobile device tells the centralized server, after being uniquely identifier thereto, to transfer a license. In return, the first mobile device receives a server-generated unique identifier for the transfer (designated here as TID).
the first mobile device signals to the second mobile device to start transfer and starts listening for contact;
if the first mobile device touches the second mobile device within 30 seconds after the signal, the TID is sent by the first mobile device to second one;
the second mobile device sends the TID to the centralized server;
the license is deactivated on the server for the first mobile device;
the second mobile device gets the available license (the second mobile device may also receive the digital content, such as the ebook);
the second mobile device now has the license, the first mobile device doesn't have it any more, and the centralized server has a trace of the whole operation making possible to find easily who has access to the digital content.

Advantageously, the last above-mentioned embodiment enables the grander of the license to keep track of each license, and guarantees that one license corresponds to one device only. Further, this embodiment permits to avoid the use of dongles, or more generally any other hardware means to counteract piracy.

Advantageously, the centralized server may keep track of content distribution and identify users who engage in illegal distribution.

It is to be noted that the above lending method of DRM-protected content is akin to a license transfer from one device to another.

Advantageously, the above described method of digital content lending excludes any widespread distribution. It authorizes the everyday operations that are historically associated to books such as lending or giving, acting as a social medium.

According to one aspect, the above described method respects the most restrictive acceptance of DRM, that only one device at a time may use a given DRM token (license, authorization for example).

According to another aspect, the above described methods simplifies digital content lending processes (for example, no need to perform complicated manipulation to lend a book), and strengthens security measures against piracy (certainly, the required physical contact between devices counteracts online piracy).

It is noteworthy to mention that advantageously, according to the above presented embodiments,
consumers can not only buy the rights to use a copyrighted digital content but also the rights to lend it to other consumers in a license/DRM controlled manner;
the rights of content providers are enforced and their business model is enhanced by imposing restrictions on the way that consumers distribute copyrighted contents;
digital contents may be transferred between end-user devices without need for intermediary memory such as a flash memory.

Persons skilled in the art will readily realize that the above described method fits well to digital contents (ebooks, movies, music files for example) lending via mobile handset devices.

1. A method for transferring a digital right management-protected digital content from a first device to a second device, said first and second devices respectively comprising a contact point, a contact communication unit and a standard communication functionality, said digital content being protected by a digital right management module, and the digital right management license, said method comprising:
sending a code from the first device to the second device;
activating the contact point and the contact communication unit of the first device;
if there is a physical contact between the contact point of the first device and the contact point of the second device within a predefined period of time, then sending the code from the second device to the first device for verification;
checking, by the first device, of the code received from the second device;
if the code received by the first device is correct, transmitting the digital right management license of the first device to the second device and deactivating the digital right management license of the first device.

2. The method of claim 1, further comprising receiving, by the second device, of the digital right management-protected digital content.

3. The method of claim 1, wherein the code sent from the first device to the second device is retrieved by the first device from a distant server.

4. The method of claim 1, wherein the digital right management license is transmitted to the second device from a distant server.

5. The method of claim 2, wherein the second device receive the digital right management-protected digital content via a communication area network to which both first and second devices are connected.

6. A device for transferring a digital right management-protected digital content comprising a contact point configured to detect its physical contact with a contact point of a second device and to enable sending a code from the said device to the said second device.

7. The device of claim 6, further comprising a contact communication unit.

8. The device of claim 6, further comprising a standard communication functionality.

9. The device of claim 6, further comprising means for transmitting a code.

10. The device of claim 6, further comprising means for retrieving a code from a distant server.

11. The device of claim 6 is a smartphone.

12. The device of claim 6 is a tablet computer.

13. A computer program including instructions stored on a memory of a computer and/or a dedicated system, wherein said computer program is adapted to perform the method as claimed in claim 1.
